(19) United States
(12) Patent Application Publication
(10) Pub. No.: US 2015/0103097 A1
(43) Pub. Date: Apr. 16, 2015

(54) Method and Device for Implementing Augmented Reality Application

(71) Applicant: Huawei Device Co., Ltd., Shenzhen (CN)

(72) Inventor: Guoqing Li, Beijing (CN)

(21) Appl. No.: 14/575,549

(22) Filed: Dec. 18, 2014

Related U.S. Application Data
(63) Continuation of application No. PCT/CN2013/085080, filed on Oct. 12, 2013.

(30) Foreign Application Priority Data
Dec. 13, 2012 (CN) 201210539054.6

(51) Int. Cl. G06F 17/30; G06K 9/46; G06T 19/00

(52) U.S. Cl. CPC G06F 17/30268; G06T 19/006; G06K 9/46
USPC 345/633

(57) ABSTRACT

A method for implementing an augmented reality application includes collecting an image and label information of the image, where the image has been uploaded by a user and releasing the image and the label information of the image to a social networking contact of the user in accordance with a social graph of the user and an interest graph. The method also includes obtaining comment information from the social networking contact about the image and extracting, from the comment information, a keyword, where an occurrence frequency of the keyword is higher than a first threshold. Additionally, the method includes adding the image to an image album in accordance with the label information of the image and the keyword and generating an augmented reality pattern and augmented reality content about a describing object of the image in accordance with image features of images in the image album and the keyword.

This application is a continuation of International Application No. PCT/CN2013/085080, filed on Oct. 12, 2013, which claims priority to Chinese Patent Application No. 201210539054.6, filed on Dec. 13, 2012, both of which are hereby incorporated by reference in their entireties.

### TECHNICAL FIELD

The present invention relates to the field of computer technologies, and in particular, to a method and device for implementing an augmented reality application.

### BACKGROUND

A concept of augmented reality (AR) was originated in the 1990s. An example virtual reality continuum takes a real environment and a virtual environment separately as two ends of a continuous system, with mixed reality located in the middle of the two ends. A part close to the real environment is the augmented reality and a part close to the virtual environment is augmented virtuality.

The augmented reality is a technology used to help people acquire related information of an object in a real world in a more intuitive and vivid manner. A processing process of an augmented reality application may be described as four steps including perceiving, identifying, matching, and rendering, which are specifically as follows:

Perceiving refers to that a user perceives various objects in the real world by using a camera and various sensors provided by a terminal device and collects various parameters such as an image, a position, a direction, a speed, a temperature, and a light intensity for an AR software to use.

Identifying refers to that the AR software processes data collected by the sensors, for example, the AR software analyzes and processes an image captured by the camera and attempts to identify an object in a photo. The AR software performs matching between a pattern of an object feature extracted from the image with a pattern stored in a local or an online pattern library. When the pattern is obtained by means of matching, identification succeeds; otherwise, identification fails.

Matching refers to that the AR software prepares multimedia content related to a pattern, such as graphic information, an audio and a video, and a three dimensional (3D) model, after identification succeeds. The media information may be locally saved to the terminal and may also be obtained online.

Rendering refers to the fact that the AR software combines the multimedia content with an image of the real world that is captured by the camera for rendering on a display device of the user's terminal.

The AR application may have good identification effects for a special type of image, such as a landmark building, a book, a famous painting, a bar code, a trademark, or a text. However, for an image that does not belong to the foregoing special types of images, an identification success rate of the AR application may not be high, types of identifiable objects and an application scenario for the AR application are limited.

### SUMMARY

Multiple aspects of embodiments of the present invention provide a method and device for implementing an augmented reality application, which can solve a problem of identifying a random object in an environment without a marker in an augmented reality application.

An embodiment method for implementing an augmented reality application includes collecting an image and label information of the image, where the image has been uploaded by a user and releasing the image and the label information of the image to a social networking contact of the user in accordance with a social graph of the user and an interest graph. The method also includes obtaining comment information from the social networking contact about the image and extracting, from the comment information, a keyword, where an occurrence frequency of the keyword is higher than a first threshold. Additionally, the method includes adding the image to an image album in accordance with the label information of the image and the keyword and generating an augmented reality pattern and augmented reality content about a describing object of the image in accordance with image features of images in the image album and the keyword.

An embodiment device includes a processor and a non-transitory computer readable storage medium storing programming for execution by the processor. The programming including instructions to collect an image and label information of the image, where the image has been uploaded by a user and release the image and the label information of the image to a social networking contact of the user in accordance with a social graph of a user interest graph on an Internet. The programming also includes instructions to obtain comment information about the image from the social networking contact and extract, from the comment information, a keyword, where a frequency of the keyword is higher than a first threshold. Additionally, the programming includes instructions to add the image to an image album in accordance with the label information of the image and the keyword and generate an augmented reality pattern and augmented reality content about a describing object of the image in accordance with image features of images in the image album and the keyword.

An embodiment method for implementing an augmented reality application includes collecting an image uploaded by a user and label information of the image, where the label information includes geographical location information of a describing object of the image and releasing the image and the label information of the image to a social networking contact of the user in accordance with a social graph of the user and an interest graph on an internet. The method also includes obtaining comment information of the social networking contact about the image and extracting, from the comment information, a keyword, where an occurrence frequency of the keyword is higher than a first threshold.

Additionally, the method includes adding the image to an image album in accordance with the label information of the image and the keyword including adding the image to an image library in accordance with the geographical location information of the describing object of the image, where describing objects of images in the image library have the geographical location information, and where the image library includes the image album and adding the image to the image album of the image library in accordance with the keyword, where images in the image album have the keyword.

Also, the method includes generating an augmented reality pattern and augmented reality content about a describing object of the image in accordance with image features of the images in the image album and the keyword including extracting the image features from the images in the image album, determining a common image feature in accordance with the image features, where the common image feature are shared by a first percentage of images of the image album, where the first percentage exceeds a second percentage, generating the augmented reality pattern of the describing object of the image in accordance with the common image feature and the keyword, adding the augmented reality pattern to an identifiable pattern library, obtaining the augmented reality content of the describing object of the image in accordance with the keyword including at least one of using a search engine or receiving from a third-party content provider, establishing an association between the augmented reality content and the augmented reality pattern, and adding the augmented reality content to an augmented reality content library.

An embodiment device for implementing an augmented reality application includes a processor and a non-transitory computer readable storage medium storing programming for execution by the processor. The programming includes instructions to collect an image uploaded by a user and label information of the image, where the label information includes geographical location information of a describing object of the image and release the image and the label information to a social networking contact of the user in accordance with a social graph of the user and an interest graph on an Internet. The programming also includes instructions to obtain comment information about the image from the social networking contact and extract, from the comment information, a keyword, where an occurrence frequency of the keyword is higher than a first threshold. Additionally, the programming includes instructions to add the image to an image album in accordance with the label information of the image and the keyword to add the image to an image library in accordance with the geographical location information of the describing object of the image, where describing objects of images in the image library have the geographical location information, and where the image library includes the image album, and add the image to the image album in the image library in accordance with the keyword, where images in the image album have the keyword.

Also, the programming includes instructions to generate an augmented reality pattern and augmented reality content of a describing object of the image in accordance with image features of the images in the image album and the keyword to extract image features from the images in the image album, determine a common image feature in accordance with the image features, where the common image features is shared a first percentage of images of the image album, where the first percentage exceeds a second percentage, generate the augmented reality pattern of the describing object of the image in accordance with the common image feature and the keyword, add the augmented reality pattern to an identifiable pattern library, obtain, in accordance with the keyword, the augmented reality content of the describing object of the image including at least one of using a search engine or receiving from a third-party content provider, establish an association between the augmented reality content and the augmented reality pattern, and add the augmented reality content to an augmented reality content library.

### BRIEF DESCRIPTION OF THE DRAWINGS

FIG. 1 is a schematic flowchart of a method for implementing an augmented reality application according to an embodiment;

FIG. 2 is a schematic flowchart of a step in the method for implementing an augmented reality application;

FIG. 3 is a schematic flowchart of another method for implementing an augmented reality application according to an embodiment;

FIG. 4 is a schematic structural diagram of a device for implementing an augmented reality application according to an embodiment;

FIG. 5 is a schematic structural diagram of an image classifying unit in a device for implementing an augmented reality application according to an embodiment;

FIG. 6 is a schematic structural diagram of an augmented reality processing unit in a device for implementing an augmented reality application according to an embodiment;

FIG. 7 is a schematic structural diagram of another device for implementing an augmented reality application according to an embodiment; and

FIG. 8 is a schematic structural diagram of a terminal according to an embodiment.

### DETAILED DESCRIPTION OF ILLUSTRATIVE EMBODIMENTS

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

In a common and unprocessed environment without a marker, any object is extracted and used as a pattern that is identified by augmented reality (AR), and related AR content is generated, so as to solve a problem of identifying a random object in the environment without a marker in an augmented reality application.

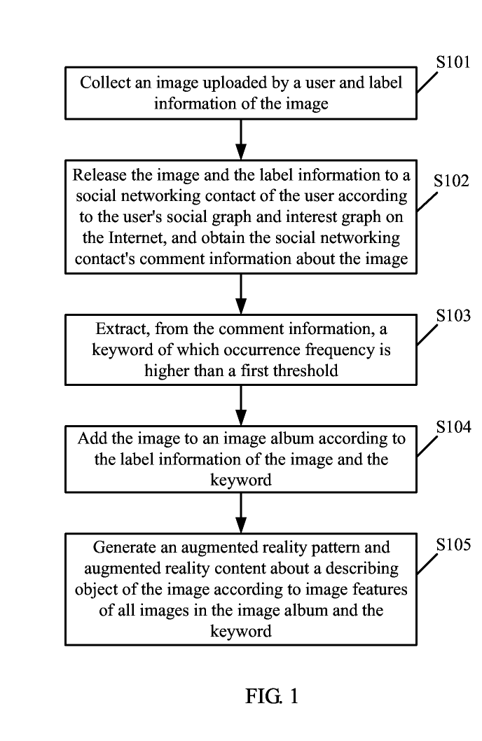

Referring to FIG. 1, FIG. 1 is a schematic flowchart of a method for implementing an augmented reality application according to an embodiment.

The method for implementing an augmented reality application provided in this embodiment includes steps S101-S105.

S101. Collect an image uploaded by a user and label information of the image.

Specifically, the label information of the image may be any content in a text format and may be content such as geographical location information of a describing object of the image, auxiliary description information of the image, and photographing time of the image. For example, a photo is taken at Tian'anmen Square, and therefore “Tian'anmen Square” is a describing object of the image; a geographical location of “Tian'anmen Square” is geographical location information of the describing object of the image; and information about a scene, building, history, and the like “Tian'anmen Square” that is added to the photo by the user is auxiliary description information of the image.

During specific implementation, a camera that has a geographical location display function is used to take a photo, and extended information may be automatically added to a photographed image in a joint photographic experts group (JPEG) format, where the extended information is saved in an exchangeable image file (EXIF) format and content of the extended information includes a geographical location (longitude, latitude, and altitude) and photographing time.

S102. Release the image and the label information to a social networking contact of the user according to the user's social graph and interest graph on the Internet, and obtain the social networking contact's comment information about the image.

With explosive development of websites such as Facebook™, social networks arouse increasing attention, and therefore concepts of a social graph and an interest graph are derived. The social graph reveals an interpersonal relationship, and the interest graph reveals a hobby and an interest of the user and a derived interpersonal relationship.

In this embodiment, according to the user's social graph and interest graph on the Internet, the image is released to the social networking contact of the user, and it may be inferred that the image is interested by the social networking contact. The comment information, about the image, obtained from the social networking contact can more accurately reflect features of a describing object of the image. By using a keyword extracted from the comment information about the image to create an augmented reality pattern and augmented reality content, a success rate of identifying a random object in an environment without a marker can be increased in the augmented reality application, thereby improving user experience.

S103. Extract, from the comment information, a keyword of which occurrence frequency is higher than a first threshold.

The keyword may be information, such as a scenery feature, culture information, and a history origin, of the describing object of the image. One or more keywords may be extracted from the comment information.

S104. Add the image to an image album according to the label information of the image and the keyword.

In an implementation manner, the label information includes the geographical location information of the describing object of the image. The foregoing step S104 includes: adding the image to an image library according to the geographical location information of the describing object of the image, where describing objects of images in the image library have same geographical location information, and the image library includes at least one image album; and adding the image to an image album of the image library according to the keyword, where images in the image album have a same keyword.

During specific implementation, an image library may be first created according to geographical location information of a describing object of an image, and images that have same geographical location information are added to a same image library. When the number of images in the image library meets a set boundary condition, at least one image album is then created in the image library according to different keywords, and images that have a same keyword are added to a same image album, thereby achieving a further classification of the images in the image library. For example, images related to a geographical location “Tian'anmen Square” are saved in an image library. This “Tian'anmen Square” image library is further divided into a “Monument to the People's Heroes” image album, a “Chairman Mao Memorial Hall” image album, and a “Zhengyangmen” image album, so that a two-level image storage structure “geographical location-based image library—keyword-based image album” is formed. The “Monument to the People's Heroes” image album is used to store images that have a keyword “Monument to the People's Heroes”, the “Chairman Mao Memorial Hall” image album is used to store images that have a keyword “Chairman Mao Memorial Hall”, and the “Zhengyangmen” image album is used to store images that have a keyword “Zhengyangmen”. Each image in a same image album has a same describing object.

The foregoing “images that have same geographical location information” does not require that geographical locations be strictly consistent, and a same geographical location herein refers to a same range. For example, when geographical location information of photos are analyzed, it is found that some photos are taken within a range of a circle of which center is the Monument to the People's Heroes and radius is 500 meters, and the photos are classified into a category.

S105. Generate an augmented reality pattern (AR pattern and augmented reality content (AR content) about a describing object of the image according to image features of all images in the image album and the keyword.

Each object in physical space has multiple features, such as a length, a width, a height, a color, a texture and a geographical location. The AR pattern refers to a group of features which are saved in a digital format and used to identify an object in the physical space in the AR application, and the features may be a color, a texture, a shape, a location, and the like.

In the AR application, digital multimedia information (an image, a text, a 3D object, and the like) is combined with a real object in the physical space, and displayed on a user terminal equipment as integrated AR experience. Herein, all multimedia information that can be used to overlay onto a real object in the physical space is the AR content.

During specific implementation, step S105 may be performed after the number of images in the image album meets a set boundary condition or the number of keywords shared by all images in the image album meets a set boundary condition. The boundary condition may be that the number of the images in the image album is greater than a set threshold of the number of images, or that the number of the keywords shared by all the images in the image album is greater than a set threshold of the number of keywords.

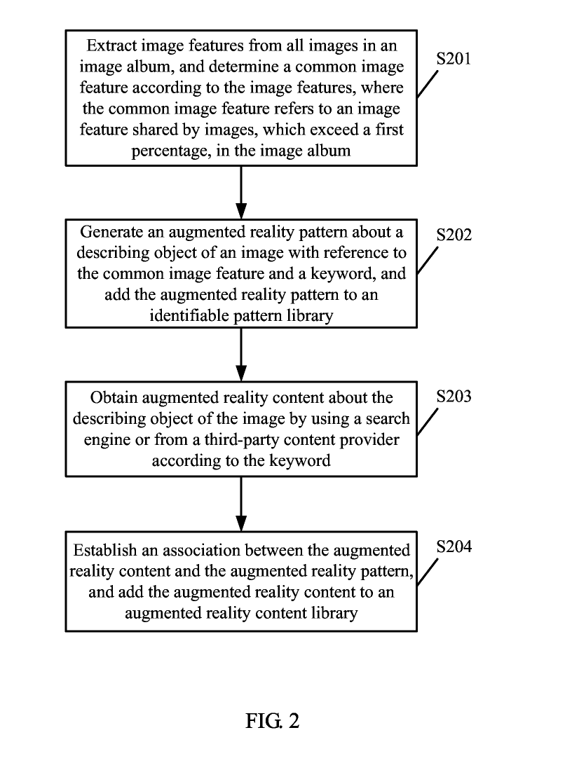

Referring to FIG. 2, step S105 may include steps S201-S204.

S201. Extract the image features from all the images in the image album and determine a common image feature according to the image features, where the common image feature refers to an image feature shared by images, which exceed a first percentage, in the image album.

The first percentage may be set according to an actual application, for example, set to 80%.

During specific implementation, an image feature is extracted from each image in the image album, and it is assumed that a total of n image features including image features X1, X2, X3, . . . , Xn are extracted. For example, an image with the “Tian'anmen Square,” and image information about “Portrait of Chairman Mao” and “The Tian'anmen Rostrum” extracted from the image is an image feature.

By separately using the image features X1, X2, X3, . . . , Xn to identify the images in the image album, a detection rate of each image feature for the images is obtained. For example, 90% of the images in the image album all have the image feature X1, and then a detection rate of the image feature X1 for the images is 90%.

After the detection rate of each image feature for the images is obtained, normalization processing is performed on detection rates. A detection rate with a maximum value among the detection rates is normalized to 1, and other detection rates obtained after normalization processing is performed are all less than 1. Each detection rate obtained after normalization processing is performed is a weighted value of an image feature corresponding to each detection rate. When a new image is added to the image album, the images in the image album are identified again according to an embodiment. A weighted value of each image feature is constantly refreshed according to an identification result each time. After multiple times of identification, an image feature of which a detection rate is greater than a threshold (for example, 0.6) for a long term is marked as a common image feature, and the common image feature and a describing object of the image (that is, an AR target) match each other. However, an image feature of which a detection rate is less than or equal to the threshold for a long term is removed.

In addition, a similarity evaluation function:

ƒ(X₁,X₂, . . . ,Xₙ,)=Σᵢ₌₁ⁿbᵢKᵢ,

may be set, where Kᵢ is a normalized weighted value of an image feature Xᵢ. When it can be determined, by using the image feature Xᵢ, that an image uploaded by a user includes the AR target, bᵢ=1. Otherwise, bᵢ=0. The weighted value is constantly refreshed according to the identification result each time, and therefore the similarity evaluation function is a dynamic updating function. A matching degree between the AR target and an image uploaded by the user may be evaluated by using the function. When an image feature is less related to the AR target, a normalized weighted value of the image feature exerts less impact on the similarity evaluation function. After multiple times of iteration, an image feature of which a normalized weighted value is less than a threshold is removed from the AR pattern.

S202. Generate the augmented reality pattern about the describing object of the image with reference to the common image feature and the keyword, and add the augmented reality pattern to an identifiable pattern library.

S203. Obtain, according to the keyword, the augmented reality content about the describing object of the image by using a search engine or from a third-party content provider.

S204. Establish an association between the augmented reality content and the augmented reality pattern, and add the augmented reality content to an augmented reality content library.

According to the method for implementing an augmented reality application provided in this embodiment, an image uploaded by a user and label information are collected, and comment information, from a social networking contact of the user, about the image is acquired; a keyword used to identify the image is extracted from the comment information; the image is added to an image album according to the label information of the image and the keyword; and according to image features of all images in the image album and the keyword, it is implemented that an augmented reality pattern and augmented reality content about a random object in an environment without a marker are automatically generated. By using the generated augmented reality pattern and augmented reality content, a problem of identifying a random object in the environment without a marker can be solved in an augmented reality application.

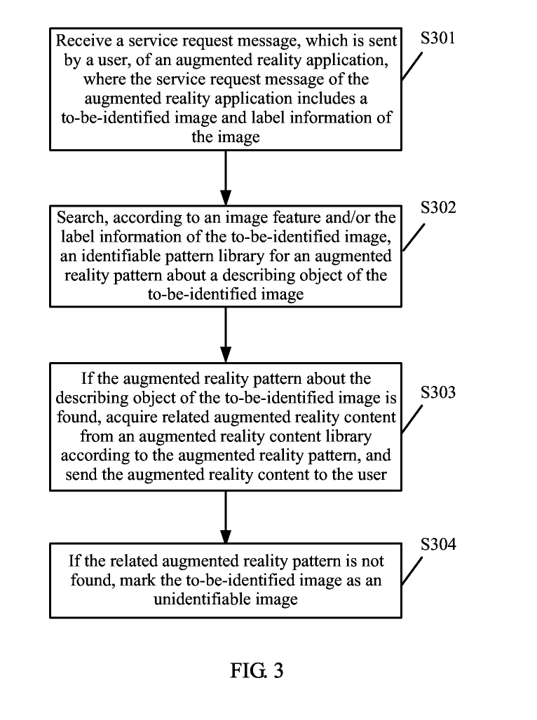

Referring to FIG. 3, FIG. 3 is a schematic flowchart of another method for implementing an augmented reality application according to an embodiment.

This method for implementing an augmented reality application provided in this embodiment includes the foregoing steps S101-S105 and S201-S204. In addition, after an augmented reality pattern and augmented reality content are generated, a random object in an environment without a marker may further be identified by using the generated augmented reality pattern and augmented reality content, which includes the following steps.

S301. Receive a service request message, which is sent by the user, of an augmented reality application, where the service request message of the augmented reality application includes a to-be-identified image and label information of the image.

S302. Search, according to an image feature and/or the label information of the to-be-identified image, the identifiable pattern library for an augmented reality pattern about a describing object of the to-be-identified image.

S303. When the augmented reality pattern about the describing object of the to-be-identified image is found, acquire related augmented reality content from the augmented reality content library according to the augmented reality pattern, and send the augmented reality content to the user.

S304. When the related augmented reality pattern is not found, mark the to-be-identified image as an unidentifiable image.

In yet another implementation, after marking the to-be-identified image as an unidentifiable image in step S304, the method of steps S101-S105 and S201-S204 in the foregoing embodiment may further be performed, so as to generate an augmented reality pattern and augmented reality content about a describing object of “the image marked as an unidentifiable image”. That is, in step S101, the collected image is an image uploaded by the user marked as an unidentifiable image. After the augmented reality pattern and the augmented reality content about the describing object of “the image marked as an unidentifiable image” are generated and when the user uploads “the image marked as an unidentifiable image” again, “the image marked as an unidentifiable image” can be identified, thereby solving a problem of identifying a random object in an environment without a marker in the augmented reality application.

In the method for implementing an augmented reality application provided in this embodiment, when a user uses an augmented reality application service, a device or a system that uses the method further has a learning capability. By using an image that fails to be identified, an augmented reality pattern and augmented reality content about a describing object of the image can be automatically generated. When the method is used for longer time and by more users, a new augmented reality pattern and new augmented reality content that are generated are richer and a device has higher availability, and therefore a problem of identifying a random object in an environment without a maker can be solved in an augmented reality application.

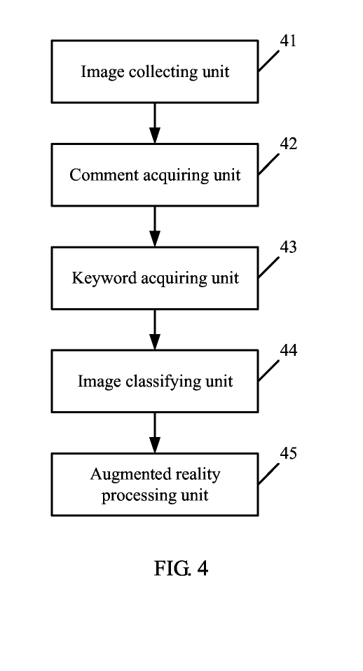

An embodiment further provides a device for implementing an augmented reality application, which can implement all processes of the foregoing methods for implementing an augmented reality application, and is described in detail with reference to FIG. 4-FIG. 7 in the following.

Referring to FIG. 4, FIG. 4 is a schematic structural diagram of a device for implementing an augmented reality application according to an embodiment.

The device for implementing an augmented reality application provided in this embodiment includes an image collecting unit 41, a comment acquiring unit 42, a keyword acquiring unit 43, an image classifying unit 44, and an augmented reality processing unit 45, which are specifically as follows:

The image collecting unit 41 is configured to collect an image uploaded by a user and label information of the image.

The comment acquiring unit 42 is configured to release the image and the label information to a social networking contact of the user according to the user's social graph and interest graph on the Internet, and obtain the social networking contact's comment information about the image.

The keyword acquiring unit 43 is configured to extract, from the comment information, a keyword of which occurrence frequency is higher than a first threshold.

The image classifying unit 44 is configured to add the image to an image album according to the label information of the image and the keyword.

The augmented reality processing unit 45 is configured to generate an augmented reality pattern and augmented reality content about a describing object of the image according to image features of all images in the image album and the keyword.

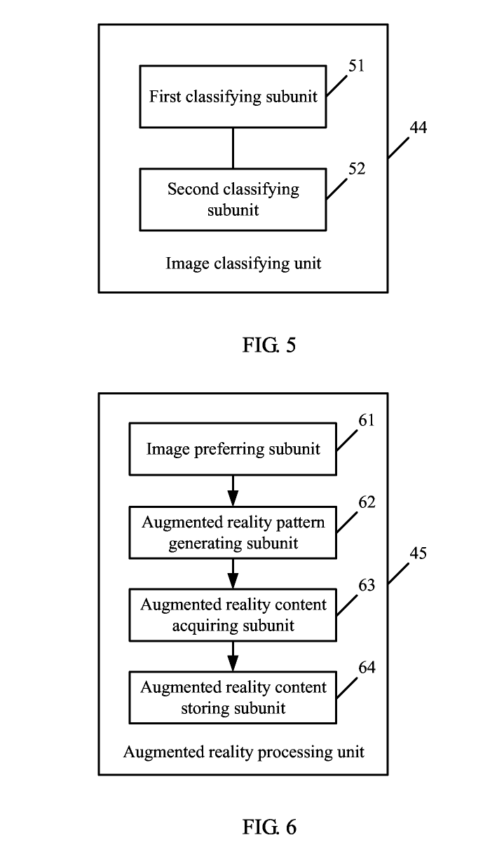

Referring to FIG. 5, FIG. 5 is a schematic structural diagram of an image classifying unit in a device for implementing an augmented reality application according to an embodiment.

The label information includes geographical location information of the describing object of the image, and the image classifying unit 44 includes a first classifying subunit 51 and a second classifying subunit 52.

The first classifying subunit 51 is configured to add the image to an image library according to the geographical location information of the describing object of the image, where describing objects of images in the image library have same geographical location information, and the image library includes at least one image album.

The second classifying subunit 52 is configured to add the image to an image album in the image library according to the keyword, where images in the image album have a same keyword.

Referring to FIG. 6, FIG. 6 is a schematic structural diagram of an augmented reality processing unit in a device for implementing an augmented reality application according to an embodiment.

The augmented reality processing unit 45 provided in this embodiment includes an image preferring subunit 61, an augmented reality pattern generating subunit 62, an augmented reality content acquiring subunit 63, and an augmented reality content storing subunit 64, which are specifically as follows:

The image preferring subunit 61 is configured to extract the image features from all the images in the image album and determine a common image feature according to the image features, where the common image feature refers to an image feature shared by images, which exceed a first percentage, in the image album.

The augmented reality pattern generating subunit 62 is configured to generate the augmented reality pattern about the describing object of the image with reference to the common image feature and the keyword, and add the augmented reality pattern to an identifiable pattern library.

The augmented reality content acquiring subunit 63 is configured to obtain, according to the keyword, the augmented reality content about the describing object of the image by using a search engine or from a third-party content provider.

The augmented reality content storing subunit 64 is configured to establish an association between the augmented reality content and the augmented reality pattern, and add the augmented reality content to an augmented reality content library.

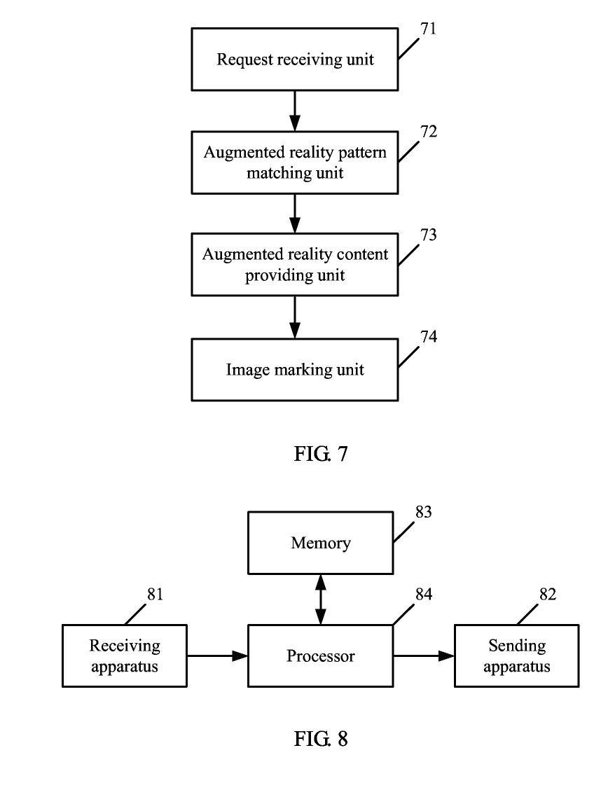

Referring to FIG. 7, FIG. 7 is a schematic structural diagram of another device for implementing an augmented reality application according to an embodiment.

In addition to the image collecting unit 41, the comment acquiring unit 42, the keyword acquiring unit 43, the image classifying unit 44, and the augmented reality processing unit 45 in the foregoing embodiment, the another device for implementing an augmented reality application provided in this embodiment further includes a request receiving unit 71, an augmented reality pattern matching unit 72, an augmented reality content providing unit 73, and an image marking unit 74, which are specifically as follows:

The request receiving unit 71 is configured to receive a service request message, which is sent by a user, of an augmented reality application, where the service request message of the augmented reality application includes a to-be-identified image and label information of the image.

The augmented reality pattern matching unit 72 is configured to search, according to an image feature and/or the label information of the to-be-identified image, the identifiable pattern library for an augmented reality pattern about a describing object of the to-be-identified image.

The augmented reality content providing unit 73 is configured to: when the augmented reality pattern about the describing object of the to-be-identified image is found, acquire related augmented reality content from the augmented reality content library according to the augmented reality pattern, and send the augmented reality content to the user.

The image marking unit 74 is configured to: when the related augmented reality pattern is not found, mark the to-be-identified image as an unidentifiable image.

In yet another implementation manner, an image collected by the image collecting unit 41 is an image uploaded by the user and marked as an unidentifiable image.

According to the device for implementing an augmented reality application provided in this embodiment, an image uploaded by a user and label information are collected, and comment information, from a social networking contact of the user, about the image is acquired; a keyword used to identify the image is extracted from the comment information; the image is added to an image album according to the label information of the image and the keyword; and according to image features of all images in the image album and the keyword, it is implemented that an augmented reality pattern and augmented reality content about a random object in an environment without a marker are automatically generated. By using the generated augmented reality pattern and augmented reality content, a problem of identifying a random object in the environment without a marker can be solved in an augmented reality application.

With reference to steps S801-S814, the following describes in detail, by using that an image uploaded by a user is a photo as an example, a processing process of a method and device for implementing an augmented reality application provided in the present embodiment.

S801. A user uses a smartphone to take a photo, a describing object in the photo is an object (AR target) which the user is interested in; and the user adds geographical location information (GeoTagging) and other user-defined label information to the photo, and then, submits the photo and a tag of the geographical location information to a device for implementing an augmented reality application (hereinafter referred to as an AR device). The AR device may implement a method for implementing an augmented reality application provided in an embodiment.

S802. The AR device performs image processing on the photo and extracts an AR pattern about the object in the photo, and when the AR pattern about the object in the photo can be obtained by means of matching in an identifiable pattern library, searches an AR content library for related AR content according to the AR pattern.

S803. The AR content library returns the found AR content to the smartphone, and then a local application on the smartphone combines the AR content and a real scenario captured by a camera into AR experience, and presents the AR experience to the user.

When the AR device cannot identify the AR pattern about the object in the photo, the processing process of the method for implementing an augmented reality application provided in the present embodiment is performed to generate AR content and an AR pattern, so as to provide a service for a next user when the user attempts again to identify the foregoing object. Steps S804-S814 are as follows:

S804. The AR device performs image processing on the photo and extracts the AR pattern about the object in the photo, but cannot find the foregoing AR pattern in the identifiable pattern library, or an AR identifying module cannot extract a valid AR pattern from the photo, so that the photo is marked as an unidentifiable image, and the photo is sent to an unidentifiable image library.

When multiple users take a large number of photos at a same place and uploaded the photos, the AR device creates an image library according to the GeoTagging and saves photos that have same geographical location information to a same image library.

S805. Acquire an unidentifiable photo and label information of the unidentifiable photo from the unidentifiable image library.

S806. Release the photo to the user's friend on a social network site according to the user's social graph on the Internet, or send the photo to a related social networking contact of the user according to a label added by the user and an interest graph of the user.

S807. After the photo is released on the social network site (SNS), the user's friend is expected to add a comment and perform a discussion for the foregoing photo, and the SNS returns comment information to the AR device.

S808. The AR device performs a comprehensive analysis on the received comment information and extracts a hot keyword or a keyword with a relatively high utilization frequency as information for describing the foregoing photo.

S809. After collecting enough keywords, the AR device performs further division on the image library created according to the geographical location information. For example, an image library saves photos related to a geographical location “Tian'anmen Square”, and keywords collected by the AR device include “Monument to the People's Heroes”, “Chairman Mao Memorial Hall”, and “Zhengyangmen”. This “Tian'anmen Square” image library may be further divided into three image albums that store photos including the foregoing three keywords separately. In this way, the image library is gradually divided into a three-level storage structure “unidentifiable image library—geographical location-based image library—keyword-based image album”.

S810. When the number of images in an image album meets a set boundary condition, an image processing algorithm is enabled, and a common image feature is extracted from photos in the image album, where for a photo of which an image feature cannot be extracted, the photo may be used as a sample to train an identification algorithm and improve identification accuracy.

S811. Generate the AR pattern about the describing object in the image with reference to the common image feature and the keyword, and save the AR pattern to an identifiable pattern library. Therefore, the identifiable pattern library becomes richer, and after an object that cannot be identified this time fails to be identified for several times, and the identifiable pattern library accumulates enough data, the object that cannot be identified this time changes to an identifiable object.

S812. Send the keyword to a search engine, and the search engine collects AR content.

S813. Save the AR content collected by the search engine to the AR content library; in addition, the AR pattern may further be provided for a third-party content provider, the third-party content provider provides AR content for the AR pattern, and this part of AR content is also stored to the AR content library.

S814. The AR content library returns a group of content to the smartphone; and the AR device on the smartphone combines virtual information and a real scenario, and presents AR experience to the user.

In conclusion, in steps S804-S814, a new AR pattern and new AR content are generated by using an unidentifiable photo uploaded by the user. If the method is used for a longer time and by more users, the new AR pattern and new AR content that are generated become richer, and an AR device has higher performance in identifying an image.

With reference to three application scenarios, the following describes in detail beneficial effects of a method and device for implementing an augmented reality application provided in the present embodiment.

A first application scenario will now be described.

A large number of visitors come to Tian'anmen Square every day, and large targets near Tian'anmen Square include the Tian'anmen Rostrum, the Golden Water Bridge, a reviewing stand, flagpoles, the Great Hall of the People, Zhengyangmen, the Monument to the People's Heroes, the Chairman Mao Memorial Hall, the National Museum, and the like. In addition, there are also some other targets that may be concerned by a user, such as sculptures in front of the Chairman Mao Memorial Hall, reliefs on the Monument to the People's Heroes, colonnades of the Great Hall of the People, entrances for the metro line 1, temporary landscapes placed in the square every Labor's Day and National Day, and the like. With reference to this application scenario, the following describes beneficial effects of a method and device for implementing an augmented reality application provided in the present embodiment.

A person A who comes from Hangzhou travels to Beijing during National Day and comes to Tian'anmen Square around which magnificent buildings deeply attracts the person A. What the person A is most interested in is a plaque on the Zhengyangmen gatehouse. The person A is fond of calligraphy and wonders who inscribed the words on the plaque on the Zhengyangmen gatehouse.

In order to make certain who inscribed the words on the plaque, the person A takes a photo of the plaque on the Zhengyangmen gatehouse and starts an AR device to attempt to identify the plaque. Unfortunately, the AR device does not successfully identify the plaque, but only prompts the person A to add some description information and geographical location information and prompts the person A to use the AR device for identification a period of time later.

The AR device sends the photo of the plaque to the person A's friends on the Renren.com, and leaves a question to them: Do you know who inscribed the words on this plaque? The AR device sends, according to an Application Programming Interface (API) provided by the Renren.com, the photo to those friends who add a calligraphy item to the person A's hobbies.

The person A's friends make comments on the photo after receiving the photo one after another. The AR device obtains all comment information by using the API on the Renren.com, and obtains a keyword “plaque” by means of analysis.

In addition, a large number of visitors gather at Tian'anmen Square for touring, and quite a few visitors who have similar interests to the person A use a same AR device to attempt to identify the plaque on the Zhengyangmen gatehouse. Within a short period, the AR device receives a large number of photos of the Zhengyangmen gatehouse (a geographical location), and obtains the keyword “plaque” by analyzing comments, of these users' friends, on the photos. Therefore, the AR device divides photos that are labeled with the plaque (from user-defined labels or the friends' comments) into a sub-album; performs image processing to extract features of this type of photo; records geographical location information and the keyword “plaque”; and saves the features (that is, an AR pattern) to an identifiable pattern library.

The AR device provides the geographical location information and the keyword “plaque” to a search engine, and the search engine retrieves a series of related content, such as an image related to the plaque, a color and a material of the plaque, time when the plaque was hanged onto the gatehouse, and a person who wrote the words on the plaque. In addition, the AR device provides the photos, the geographical location information, and the keyword “plaque” to a third-party content provider of the AR device. The content provider has detailed information of old Beijing's commercial plaques and gate tower plaques, and records writers of the plaques and lifetimes of the writers. After the content is retrieved, the content is returned to an AR content library and is associated with the foregoing extracted AR pattern.

Next day, the person A comes to the Zhengyangmen gatehouse together with a friend D in Beijing. When the person A uses the AR device again to attempt to identify the plaque, the person A is surprised to find that the plaque is successfully identified, and obtains information and a lifetime of the writer of the plaque. The person A gladly shares the story about the plaque with the friend.

A second application scenario will now be described.

The National Museum often holds exhibitions of cultural relics and works of art. Recently, the National Museum will launch a “Buddha Statue Exhibition”, and the exhibition is scheduled to last for three months. A preview is provided during the first two weeks when a part of experts and a specific number of audiences are invited for visiting, and the exhibition opens to normal audiences for visiting two weeks later. In addition, the National Museum uses a method and device for implementing an augmented reality application provided in the present embodiment. An AR background is connected to a database and an internal search engine of the National Museum. When entering the National Museum, audiences can download and install the AR device by using a wireless connection, and a user is prompted to offer, by using the AR device, help to improve the exhibition, so that more content is provided for the normal audiences.

Most of a first group of invited audience members cooperate with a sponsor and install the AR device. They are experts in the field of Buddha statues, and deeply feel that an introductory text is extremely simple and provided related information is not rich enough when visiting the exhibition. Therefore, the experts take out mobile phones to take photos of and make comments on the Buddha statues in various shapes by using the AR device.

The experts' photos and comments are quickly uploaded to the AR background. The AR device classifies the photos according to the experts' comments (such as labels added by the experts and experts' questions on the Buddha statues); precisely divides the collected photos into sub-albums; and extracts an AR pattern and saves the AR pattern to a pattern library. In addition, the AR device sends the experts' photos to the experts' friends who cannot visit the exhibition themselves, and the experts' friends publish a large number of comments on and questions about the photos. The AR device collects the comments and the questions and extracts a keyword.

The AR device analyzes the experts' comments and questions raised by the experts; obtains some keywords and key questions; and then retrieves, from the database of the National Museum, a large amount of related content, where the related content used as AR content is associated with the foregoing generated AR pattern.

Two weeks later, the AR device accumulates enough AR patterns and AR content associated with the AR patterns. After the exhibition opens to normal audiences for visiting, the normal users, by using the AR device, can easily identify the Buddha statues in a camera and obtain detailed information such as dynasties, origins and names of the Buddha statues.

A third application scenario will now be described.

A person A and a person B establish a friend relationship on the image-sharing social networking site Instagram™. The two persons share a common hobby in liking pet cats. The person A and person B also care about stray cats near their home and often take photos for sharing. Both the two persons are users of an AR device disclosed in the present embodiment.

The person A attempts to identify a stray cat near the person A's home by using the AR device on the person A's terminal, but because there is no “pattern” about the cat in a pattern library on a background of the AR device, identification fails. The person A adds a label “uncle cat” to the photo and submits the photo to the AR device.

The AR device invokes an API provided by an SNS website to send the unidentifiable photo to a friend B on the SNS. The friend B adds a comment “the uncle cat is a senior employee in the Xinhua News Agency” to the photo, and then the AR device can extract a keyword uncle cat from the friend B's comment. If it is assumed that there are a large number of photos, which have different geographical locations and have labels “uncle cat”, in an unidentifiable image library in the AR device, the photo may be added to a photo sub-album of which a geographical location is the person A's home and a label is “uncle cat.” The sub-album further includes some uploaded photos, which are labeled with “uncle cat”, taken by other users near the person A's home.

The AR device finds, according to a geographical location, user-defined auxiliary information, and a user relationship, a photo that is about the cat and taken nearby the geographical location of the person A's home and a photo that is about the cat and taken nearby the friend B's home. Geographical location information of the two images is different, and the two images belong to different image albums. However, both the two photos include the label “uncle cat”, and the AR device considers that there is an inherent relationship between this two types of photos. Therefore, the two image albums are integrated into one sub-album, so that photo classifying is not limited by a geographical location.

When the AR device acquires a specific number of photos that have an inherent relationship (such as having a same label), image features of photos that have the label “uncle cat” are obtained by means of feature extraction, for example, features, such as a decorative pattern and a color. The image features are used as a pattern registered with the AR device, so that the AR device obtains a new identifiable AR pattern.

The background of the AR device is connected to a third-party content provider, such as a pet hospital website. The website provides, for the AR device, some service information customized for pet cats. The AR device collects, by using a search engine, some information such as photos of adorable pet cats and precautions for raising cats.

When the person A or friend B uses the AR device again to identify the foregoing photo of the cat later, this object can be identified because the AR pattern about the cat is registered with the AR device, and a user of the AR device is provided with AR content, such as service information provided by a pet hospital, information found by the search engine, and comments on the cat from the person A and friend B.

According to the method and device for implementing an augmented reality application provided in embodiments of the present embodiment, an image uploaded by a user and label information are collected, and comment information, from a social networking contact of the user, about the image is acquired; a keyword used to identify the image is extracted from the comment information; the image is added to an image album according to the label information of the image and the keyword; and according to image features of all images in the image album and the keyword, it is implemented that an augmented reality pattern and augmented reality content about a random object in an environment without a marker are automatically generated. By using the generated augmented reality pattern and augmented reality content, a problem of identifying a random object in the environment without a marker can be solved in an augmented reality application.

Referring to FIG. 8, an embodiment of the present embodiment provides a terminal, which includes a receiving apparatus 81, a sending apparatus 82, a memory 83, and a processor 84.

In addition to a connection manner shown in FIG. 8, in some other embodiments of the present embodiment, the receiving apparatus 81, the sending apparatus 82, the memory 83, and the processor 84 may further be connected by using a bus. The bus may be an Industry Standard Architecture (ISA) bus, a Peripheral Component (PCI) bus, an Extended Industry Standard Architecture (EISA) bus, or the like. The bus may have one or more physical lines, and when the bus has multiple physical lines, the bus may be classified into an address bus, a data bus, a control bus, and the like.

The processor 84 may perform the following steps: collecting, by using the receiving apparatus 81, an image uploaded by a user and label information of the image; releasing, according to the user's social graph and interest graph on the Internet, the image and the label information to the user's social networking contact by using the sending apparatus 82, and obtaining the social networking contact's comment information about the image by using the receiving apparatus 81; extracting, from the comment information, a keyword of which occurrence frequency is higher than a first threshold; adding the image to an image album according to the label information of the image and the keyword; and generating an augmented reality pattern and augmented reality content about a describing object of the image according to image features of all images in the image album and the keyword.

The memory 83 is configured to store a program that needs to be executed by the processor 84. Further, the memory 83 may store a result generated by the processor 84 in a computing process.

The embodiment further provides a computer storage medium. The computer storage medium stores a computer program, and the computer program may perform steps in the embodiments shown in FIG. 1-FIG. 3.

It should be noted that the described apparatus embodiment is merely exemplary. The units described as separate parts may or may not be physically separate, and parts displayed as units may or may not be physical units, may be located in one position, or may be distributed on a plurality of network units. A part or all of the modules may be selected according to actual needs to achieve the objectives of the solutions of the embodiments. In addition, in the accompanying drawings of the apparatus embodiments provided by the present invention, a connection relationship between modules indicates that a communication connection exists between them, which may be specifically implemented as one or more communications buses or signal cables. Persons of ordinary skill in the art may understand and implement the embodiments of the present invention without creative efforts. Based on the foregoing descriptions of the embodiments, persons skilled in the art may clearly understand that the present invention may be implemented by software in addition to necessary universal hardware or by dedicated hardware including a dedicated integrated circuit, a dedicated central processing unit (CPU), a dedicated memory, a dedicated component and the like. Generally, all functions that can be performed by a computer program can be easily implemented by using corresponding hardware. Moreover, specific hardware structures used to achieve a same function may be varied, for example, an analog circuit, a digital circuit, a dedicated circuit, or the like. However, as for the present invention, software program implementation is a better implementation manner in most cases. Based on such an understanding, the technical solutions of the present invention essentially or the part contributing to the prior art may be implemented in a form of a software product. The computer software product is stored in a readable storage medium, such as a floppy disk, a Universal Serial Bus (USB) flash disk, a mobile hard disk, a read-only memory (ROM), a random access memory (RAM), a magnetic disk, or an optical disc of a computer, and includes several instructions for instructing a computer device (which may be a personal computer, a server, a network device, and the like) to perform the methods described in the embodiments of the present invention.

The foregoing descriptions are merely specific implementation manners of the present invention, but are not intended to limit the protection scope of the present invention. Any variation or replacement readily figured out by persons skilled in the art within the technical scope disclosed in the present invention shall fall within the protection scope of the present invention. Therefore, the protection scope of the present invention shall be subject to the protection scope of the claims.

What is claimed is:

1. A method for implementing an augmented reality application, the method comprising:
collecting an image and label information of the image, wherein the image has been uploaded by a user;
releasing the image and the label information of the image to a social networking contact of the user in accordance with a social graph of the user and an interest graph;
obtaining comment information from the social networking contact about the image;
extracting, from the comment information, a keyword, wherein an occurrence frequency of the keyword is higher than a first threshold;
adding the image to an image album in accordance with the label information of the image and the keyword; and
generating an augmented reality pattern and augmented reality content about a describing object of the image in accordance with image features of images in the image album and the keyword.

2. The method of claim 1, wherein the label information comprises geographical location information of the describing object of the image, wherein adding the image to the image album comprises:
adding the image to an image library in accordance with the geographical location information of the describing object of the image, wherein the describing object of the image in the image library has the geographical location information, and wherein the image library comprises the image album; and
adding the image to the image album of the image library in accordance with the keyword, wherein images in the image album have the keyword.

3. The method of claim 1, wherein generating the augmented reality pattern and the augmented reality content comprises:
extracting the image features from the images in the image album;
determining a common image feature in accordance with the image features, wherein a first percentage of images in the image album have the common image feature, wherein the first percentage is greater than a second percentage;
generating the augmented reality pattern in accordance with the common image feature and the keyword;
adding the augmented reality pattern to an identifiable pattern library;
obtaining the augmented reality content of the describing object of the image comprising using a search engine or receiving the augmented reality content from a third-party content provider in accordance with the keyword;
establishing an association between the augmented reality content and the augmented reality pattern; and
adding the augmented reality content to an augmented reality content library.

4. The method of claim 3, further comprising:
receiving a service request message from the user of an augmented reality application, wherein the service request message comprises a to-be-identified image and label information of the to-be-identified image, after generating the augmented reality pattern and the augmented reality content;
searching, in accordance with at least one of an image feature of the to-be-identified image and the label information of the to-be-identified image, the identifiable pattern library for an augmented reality pattern of a describing object of the to-be-identified image;
acquiring related augmented reality content from the augmented reality content library in accordance with the augmented reality pattern and sending the augmented reality content to the user when the augmented reality pattern is found; and
marking the to-be-identified image as an unidentifiable image when the augmented reality pattern is not found.

5. The method of claim 1, wherein the image is marked as an unidentifiable image.

6. A device comprising:
a processor; and
a non-transitory computer readable storage medium storing programming for execution by the processor, the programming including instructions to:
collect an image and label information of the image, wherein the image has been uploaded by a user;
release the image and the label information of the image to a social networking contact of the user in accordance with a social graph of a user interest graph on an Internet;
obtain comment information about the image from the social networking contact;
extract, from the comment information, a keyword, wherein a frequency of the keyword is higher than a first threshold;
add the image to an image album in accordance with the label information of the image and the keyword; and
generate an augmented reality pattern and augmented reality content about a describing object of the image in accordance with image features of images in the image album and the keyword.

7. The device of claim 6, wherein the label information comprises geographical location information of the describing object of the image; and the image classifying unit comprises, and wherein the programming further comprises instructions to:
add the image to an image library in accordance with the geographical location information of the describing object of the image, wherein describing objects of images in the image library have the geographical location information, and wherein the image library comprises the image album; and
add the image to the image album in the image library in accordance with the keyword, wherein images in the image album have the keyword.

8. The device of claim 6, wherein the programming further comprises instructions to:
extract image features from the images in the image album;
determine a common image feature in accordance with the image features, wherein the common image is shared by images of the image album, wherein a percentage of images of the image album having the common image feature exceeds a first percentage;
generate the augmented reality pattern of the describing object of the image in accordance with the common image feature and the keyword,
add the augmented reality pattern to an identifiable pattern library;
obtain the augmented reality content of the describing object of the image in accordance with the keyword, comprising at least one of using a search engine or receiving, from a third-party content provider;
establish an association between the augmented reality content and the augmented reality pattern; and
add the augmented reality content to an augmented reality content library.

9. The device of claim 8, wherein the programming further includes instructions to:
receive a service request message, which is sent by the user, of an augmented reality application, wherein the service request message of the augmented reality application comprises a to-be-identified image and label information of the image;
search, in accordance to at least one of an image feature of the to-be-identified image and the label information of the to-be-identified image, an identifiable pattern library for an augmented reality pattern about a describing object of the to-be-identified image;
acquire related augmented reality content from the augmented reality content library in accordance with the augmented reality pattern and send the augmented reality content to the user, when the augmented reality pattern is found; and
mark the to-be-identified image as an unidentifiable image when the augmented reality pattern is not found.

10. The device of claim 6, wherein the image has been marked as an unidentifiable image.

11. A method for implementing an augmented reality application, the method comprising:
collecting an image uploaded by a user and label information of the image, wherein the label information comprises geographical location information of a describing object of the image;
releasing the image and the label information of the image to a social networking contact of the user in accordance with a social graph of the user and an interest graph on an internet;
obtaining comment information of the social networking contact about the image;
extracting, from the comment information, a keyword, wherein an occurrence frequency of the keyword is higher than a first threshold;
adding the image to an image album in accordance with the label information of the image and the keyword by:
adding the image to an image library in accordance with the geographical location information of the describing object of the image, wherein describing objects of images in the image library have the geographical location information, and wherein the image library comprises the image album; and
adding the image to the image album of the image library in accordance with the keyword, wherein images in the image album have the keyword; and
generating an augmented reality pattern and augmented reality content about a describing object of the image in accordance with image features of the images in the image album and the keyword by:
extracting the image features from the images in the image album;
determining a common image feature in accordance with the image features, wherein the common image feature are shared by a first percentage of images of the image album, wherein the first percentage exceeds a second percentage;
generating the augmented reality pattern of the describing object of the image in accordance with the common image feature and the keyword;
adding the augmented reality pattern to an identifiable pattern library;
obtaining the augmented reality content of the describing object of the image in accordance with the keyword comprising at least one of using a search engine or receiving from a third-party content provider;
establishing an association between the augmented reality content and the augmented reality pattern; and
adding the augmented reality content to an augmented reality content library.

12. The method of claim 11, further comprising:
receiving a service request message, after generating the augmented reality pattern and the augmented reality content, from the user of an augmented reality application, wherein the service request message of the augmented reality application comprises a to-be-identified image and label information of the to-be-identified image;
searching, in accordance with at least one of an image feature of the to-be-identified image and the label information of the to-be-identified image, the identifiable pattern library for an augmented reality pattern of a describing object of the to-be-identified image;
acquiring related augmented reality content from the augmented reality content library in accordance with the augmented reality pattern and sending the augmented reality content to the user when the augmented reality patter is found; and
marking the to-be-identified image as an unidentifiable image when the augmented reality pattern is not found.

13. The method of claim 12, wherein the image has been marked as an unidentifiable image.

14. A device for implementing an augmented reality application, the device comprising:
a processor; and
a non-transitory computer readable storage medium storing programming for execution by the processor, the programming including instructions to:
collect an image uploaded by a user and label information of the image, wherein the label information comprises geographical location information of a describing object of the image;
release the image and the label information to a social networking contact of the user in accordance with a social graph of the user and an interest graph on an Internet;
obtain comment information about the image from the social networking contact;
extract, from the comment information, a keyword, wherein an occurrence frequency of the keyword is higher than a first threshold;
add the image to an image album in accordance with the label information of the image and the keyword to:
add the image to an image library in accordance with the geographical location information of the describing object of the image, wherein describing objects of images in the image library have the geographical location information, and wherein the image library comprises the image album; and
add the image to the image album in the image library in accordance with the keyword, wherein images in the image album have the keyword; and
generate an augmented reality pattern and augmented reality content of a describing object of the image in accordance with image features of the images in the image album and the keyword to:
extract image features from the images in the image album;
determine a common image feature in accordance with the image features, wherein the common image features is shared a first percentage of images of the image album, wherein the first percentage exceeds a second percentage;
generate the augmented reality pattern of the describing object of the image in accordance with the common image feature and the keyword;
add the augmented reality pattern to an identifiable pattern library;
obtain, in accordance with the keyword, the augmented reality content of the describing object of the image comprising at least one of using a search engine or receiving from a third-party content provider;
establish an association between the augmented reality content and the augmented reality pattern; and
add the augmented reality content to an augmented reality content library.

15. The device of claim 14, wherein the programming further includes instructions to:
receive a service request message, from the user of an augmented reality application, wherein the service request message of the augmented reality application comprises a to-be-identified image and label information of the to-be-identified image;
search, in accordance with at least one of an image feature of the to-be-identified image and the label information of the to-be-identified image, the identifiable pattern library for an augmented reality pattern of a describing object of the to-be-identified image;
acquire related augmented reality content from the augmented reality content library according to the augmented reality pattern and send the augmented reality content to the user, when the augmented reality pattern has been found; and
mark the to-be-identified image as an unidentifiable image when the augmented reality pattern has not been found.

16. The device of claim 14, wherein the image has been marked as an unidentifiable image.
